(19) United States
(12) Patent Application Publication
(10) Pub. No.: US 2023/0173797 A1
(43) Pub. Date: Jun. 8, 2023

(54) MULTILAYER BLOCKED FILM COMPOSITE

(71) Applicants: Alfons KRUSE, Dinklage (DE); Andreas NEUMANN, Halle (DE)

(72) Inventors: Alfons KRUSE, Dinklage (DE); Andreas NEUMANN, Halle (DE)

(21) Appl. No.: 18/084,259

(22) Filed: Dec. 19, 2022

(30) Foreign Application Priority Data
Feb. 21, 2021 (EP) 21216749.8

(51) Int. Cl. B32B 27/08; B32B 27/30; B65D 65/40; B32B 27/32; B32B 7/12; B32B 27/40

(52) U.S. Cl. CPC B32B 27/08; B32B 27/306; B65D 65/40; B32B 27/327; B32B 7/12; B32B 27/40; B32B 2307/516; B32B 2307/4023; B32B 2307/72; B32B 2250/246; B32B 2307/732; B32B 2439/46; B32B 2307/31; B32B 2270/00; B32B 2307/54; B32B 2307/584; B32B 2307/581; B32B 2307/7244

(57) ABSTRACT

A polyolefin-based film composite has a uniaxially stretched first film layer and a second film layer bonded directly or indirectly to the first film layer. The second film layer is unstretched and has at least two integrally blocked film sublayers. A third film layer between the first and second layers can act as a barrier.

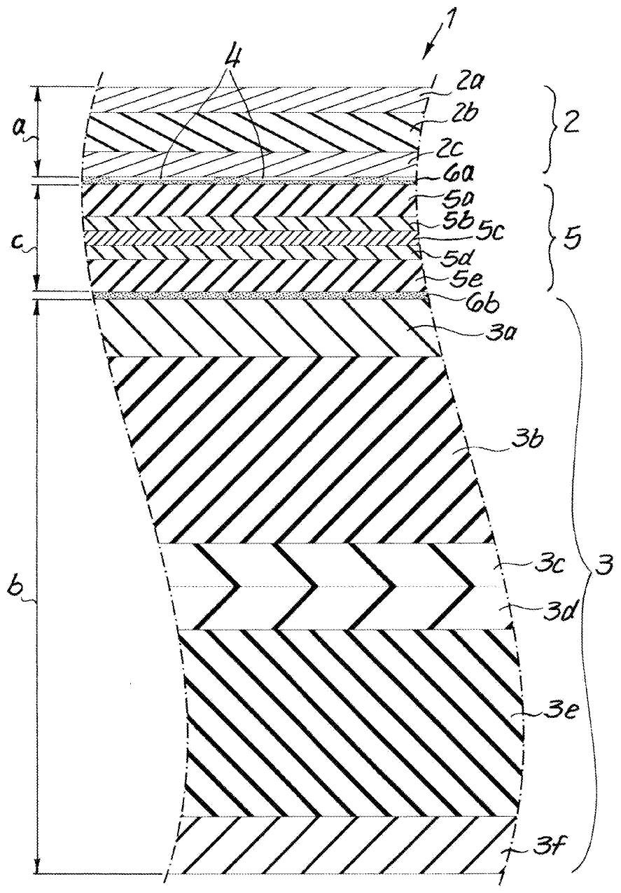

### FIELD OF THE INVENTION

The present invention relates to a polyolefin-based film composite. More particularly this invention concerns such a composite having a first uniaxially stretched or oriented film layer and a second film layer directly or indirectly integrally laminated with the first film layer.

Furthermore, the invention relates to a film package comprising a film composite material according to the invention.

### BACKGROUND OF THE INVENTION

A film composite is a composite material composed of several film layers, in which the advantageous material properties of the individual layers are combined. The film layers are formed from single- or multilayer plastic films that are produced separately from one another and then bonded together over their entire surface. In particular, a laminating adhesive can be used for this purpose.

Due to their versatility, film composite materials are often used as packaging materials, for example in pouch packaging. In the past, the different requirements of film layers made of different materials were taken into account: For example, abrasion-resistant and hard-wearing film layers made of polyesters, such as polyethylene terephthalate (PET) or of biaxially oriented polypropylene (BOPP), were frequently used as outer layers.

On the inside, on the other hand, layers of easily and viscously melting polyolefins, such as polyethylene (PE), are frequently used as so-called “seal layers.” These serve to bond the film laminate/film composite with sealable plastic surfaces, such as films and film laminates of the same or different types.

Additional barrier sublayers, such as metal foils or metalized plastic films, are and have been provided in many cases between the outer and seal layers. These serve to lower the permeability of the film composite, especially with respect to oxygen and/or water vapor.

However, this diverse mixture of different materials turns out to be very problematic in terms of sustainability. Due to the almost inseparable composite of different plastic materials, single-variety recycling is not possible. Additional interfering materials, such as metallic components, also continue to reduce the recyclability of the previous composite materials.

The invention is therefore based on a so-called “single-material” polymer material that is of polyolefin base. In the context of the present invention, this is to be understood as meaning that the film composite (or a single film layer) is made from one or more polymer materials that are predominantly (i.e. at least 50% by weight) formed from one or more polyolefins or mixtures or copolymers thereof. Here, it comes into play that polyolefins have similar chemical properties and are therefore particularly well suited to be recycled together. In particular, the invention relates to a film composite based on either polyethylene (PE) or polypropylene (PP). This makes it possible to recycle the material in an almost homogeneous manner. Such a material is known for example from U.S. Pat. No. 11,465,394.

However, the problem here is that conventional formulations and structures of polyolefin-based film layers, especially those made of PE and/or PP, have so far failed to perform like equivalent multilayer blocked film composite (made of PET or BOPP) or metal-containing barrier sublayers. Compared to film layers made of PET, polyamide (PA) or biaxially oriented polypropylene, film layers made of a polyolefin, in particular PE, exhibit lower stiffness and lower thermal dimensional stability. As a result, the film composites formed from them can develop a waviness when exposed to heat, for example during a welding process, which is a disadvantage down the line. The end product formed from this, for example a packaging bag, also exhibits increased waviness as a result, which makes handling and filling more difficult and also leads to an unsightly appearance. With respect to film blocking, see “Blocking of Films” 21 May 2018 by SHS Extrusion Training (https://www.extrusion-training.de/en/ver-blocken-von-folie-ursachen-und-loesungsansaetze/).

### OBJECTS OF THE INVENTION

It is therefore an object of the present invention to provide an improved multilayer blocked film composite.

Another object is the provision of such an improved multilayer blocked film composite that overcomes the above-given disadvantages, in particular that performs very well with a reduced wall thickness and mass.

A further object is to further develop a polyolefin-based film composite such that it exhibits mechanical properties comparable to conventional multimaterial composites. By dispensing with plastics of other types, such as PET, the recyclability of the composite material can be significantly increased. At the same time, the CO₂ balance is also improved, since, in addition to a potential material saving, less CO₂ is released in the production of polyethylene, for example, than in a comparable quantity of a plastic such as polyethylene terephthalate or polyamide.

### SUMMARY OF THE INVENTION

A polyolefin-based film composite has according to the invention a uniaxially stretched first film layer and a second film layer bonded directly or indirectly to the first film layer. The second film layer is unstretched and has at least two integrally blocked film sublayers. Thus the invention starts from a polyolefin-based film composite with a first stretched film layer and with a second film layer connected directly or indirectly to the first film layer. Furthermore according to the invention the second film layer is unstretched and has at least two integrally blocked film sublayers. By combining these two film layers, an optimization of the mechanical properties of the film composite can be achieved within the scope of the invention. Thus, an improved bending stiffness of the film composite or film laminate can be achieved in particular also in the case of so-called single-material structures.

Both the material webs of the film composite according to the invention and film packages produced from them (such as film bags) therefore exhibit lower waviness and better flatness in practice. Within the scope of the invention, the particularly good stability of a uniaxially, especially in machine direction (MD) stretched first film layer is combined with the improved stiffness of an integrally blocked second film layer.

The stabilization of a blocked film sublayer is based on the effect that (especially multilayer) films often exhibit intrinsic mechanical stresses as a result of solidification and cooling processes during production. These stresses cause undesirable waviness in the cooled film web or in the product.

In the context of the invention, it is envisaged that this effect is compensated for by blocking two films together. For this purpose, two single sublayer or multi-sublayer films, preferably heated, are brought into surface contact with two film sublayers turned toward each other, so that they are permanently bonded to each other. In this process, a first integrally blocked film sublayer (first blocked sublayer) comes into contact with a second integrally blocked film sublayer (second blocked sublayer) that has an almost identical (at least 95% by weight), preferably completely identical, polymer composition. The uniformity of the polymers guarantees particularly good cohesion.

Preferably, the first blocked sublayer is part of a first partial film (first block film) and the second blocked sublayer is part of a second partial film (second block film) that are integrally blocked to form the second film layer. The first block film and the second block film particularly preferably have an identical structure with a reversed sequence of the individual film layers. Thus, internally, an identical first blocked sublayer and an identical second blocked sublayer are directly in contact with each other to form the integrally blocked layer. In this preferred embodiment, a particularly smooth and at the same time stable film layer can be produced, since the stresses arising in the two block films as a result of the manufacturing process are in each case opposite to one another due to the reversed layer structure and are of similar magnitude and therefore cancel each other out. In addition, the mechanical stress between the two integrally blocked block films increases the stiffness of the film layer and thus of the entire film composite.

According to a particularly preferred embodiment, the first block film and the second block film are parts of a blown film tube that is integrally blocked with itself. In this way, it can be ensured that the material properties and the material composition of the first block film and the second block film are always so similar to each other (at least locally) that a consistent force balance can be achieved over the entire film layer. It is also possible in this way to combine the block films even during the blown film process. In this way, blocking is particularly favored at an elevated temperature at which the block films can form high bonding forces between each other.

Preferably, the first film layer has a print layer. This can therefore also be referred to as the “print layer.” The print layer comprises pigments with which the outer appearance of the film composite, and thus of a packaging bag made from it, can be influenced. In particular, the first film layer thereby forms a first outer face of the film composite. In addition to the pigments, the print layer preferably has nitrocellulose (NC or cellulose nitrate) and/or polyvinyl butyral (PVB) or polyurethane (PU) as binders.

According to a particularly preferred embodiment, the print is positioned on an inner face of the first film layer turned toward the second film layer. This is also referred to as inner or intermediate layer printing or counter printing.

According to a preferred embodiment, the film composite comprises, in addition to the uniaxially stretched first film layer (in particular MDO-PE) and the integral, non-stretched second film layer, at least one third film layer. This can for example take on a further function compared to the first film layer and the second film layer, for example as a barrier or seal.

The blocked, unstretched second film layer preferably forms an outer face of the film composite and is a seal layer that has at least one low-melting seal sublayer that has a lower melting temperature than the other sublayers, in particular a lower melting temperature than the outermost sublayer opposite the seal layer. In particular, this first layer can carry print or indicia.

The seal layer is used to enable bonding of the film composite by so-called heat sealing. In this process, the seal layer is melted, or at least fused or plasticized, by local heating. In this state, it can form a permanent bond with another film or another (preferably similar) film composite. After cooling, the result is a firm mechanical bond.

The polymer composition of the seal layer is designed in such a way that, when the entire film composite is heated to a specified sealing temperature, the seal layer is fused but the other film layers do not undergo any irreversible changes. In particular, it must be ensured that the uniaxially stretched first film layer is not melted nor is the orientation of the material impaired. The temperature range below such a limit temperature and above the temperature at which the seal layer fuses (in each case taking into account the welding time and welding pressure) is also referred to as the “welding window.” Its limit values are largely determined by the composition of the film composite.

Particularly preferably, the seal layer contains a proportion of HDPE of at least 30% by weight. The HDPE is preferably concentrated in one or more film sublayers (core sublayers) or exclusively in the core sublayers. In particular, the core sublayers are not on an outer face of the seal layer but are covered on the outside by at least one further film sublayer. The HDPE contributes to a considerable improvement of the mechanical properties. In particular, the strength and stiffness of the film layers can be improved.

Furthermore, the seal layer comprises at least one seal sublayer with at least 20% by weight of a PE with a density of not more than 0.905 g/cm³ (in particular ULDPE, VLDPE and/or VLDPE-m). These synthetic resins are characterized by good meltability.

Furthermore, the seal layer preferably contains at least 70% by weight of polyethylene having a density of not more than 0.92 g/cm³ (LDPE, ULDPE, VLDPE, LLDPE, VLDPE-m and/or LLDPE-m).

For improved recyclability, at least 70% by weight of the seal layer consists of homopolymers and α-olefin copolymers. In a particularly preferred variant, the seal layer contains correspondingly less than 30% by weight of vinyl or butyl copolymers with limited recyclability, such as EVA (ethylene vinyl acetate).

Very preferably, the formulation of the seal layer also contains a PE plastomer. In this case, the PE plastomer particularly preferably accounts for at least 30% by weight, in particular between 30% and 50% by weight of the seal layer. Plastomers are very low-density ethylene-α-olefin copoylmers that have elastomeric properties and very good welding properties. They combine the properties of an elastomer with those of a thermoplastic. Corresponding materials are available under the trade names Exact (Exxon Mobile), Engage (Dow) or Queo (Borealis).

According to a particularly preferred embodiment, the invention relates to a film composite that is a “single-material” system with a single dominant polymer type or a few dominant polymers. The film composite is thus particularly well suited for “single-sort” recycling.

Within the scope of the invention, it is also possible for the unstretched integrally blocked second film layer to be on the inside. In particular, it can be directly adjacent the first film layer and covered on the face turned away from the first film layer by one or more third film layers.

For this purpose, all film layers are based either on polyethylene (PE) or on polypropylene (PP). This means that within the first film layer, within the second film layer, and optionally within one or more third film layers of the film composite, the sum of the weight proportions of polyethylene or of polypropylene and variants thereof (in particular linear polyethylene, metallocene-catalyzed polyethylene and copolymers thereof) is at least 50%, preferably at least 90%, very particularly preferably at least 95%. This ensures that, in the case of recycling by melting, a reasonably uniform plastic recyclate with technically usable properties is obtained.

Particularly preferably, the individual film layers are each composed of one or more film layers each having uniform material properties. According to a particularly preferred embodiment of the invention, each of these individual film layers is based on PE or PP according to the above criteria.

According to a very particularly preferred embodiment of the invention, in the film composite, preferably all film layers, very preferably all film layers, are based on polyethylene. Thus, this embodiment relates to a “single-material” combination in the strictest sense, which can be recycled by melting to form a plastic recyclate made of multimodal polyethylene that is almost immediately ready for use. Within the framework of the structure of the film layers according to the invention, it is nevertheless possible to achieve mechanical properties that were previously only possible in the combination of different polymer materials.

According to a preferred embodiment of the invention, the film composite is free of film layers comprising oriented polypropylene (OPP) or biaxially oriented polypropylene (BOPP). It is also preferred in the context of the invention that the film composite is free of polyethylene terephthalate (PET), in particular free of any polyester, that is it only contains a single (uniaxially) oriented sublayer. The reduction or complete elimination of these previously common materials can lead to a reduction in manufacturing costs and also, in particular, to a reduction in the carbon dioxide (CO₂) produced during manufacture. This is to be welcomed from a business and environmental point of view. At the same time, mechanical parameters suitable for the application can be achieved within the framework of the layer and laminated structure according to the invention.

According to a preferred embodiment, at least one third film layer is a barrier. This has at least one barrier sublayer that can contain ethylene-vinyl alcohol copolymer (EVOH). Preferably, the barrier sublayer is formed predominantly, in particular 100%, from EVOH. The EVOH preferably contains between 24% and 48% by weight, in particular about 32%, ethylene.

Alternatively, the barrier sublayer is based on polyvinyl alcohol (PVOH). Here, too, the barrier sublayer is predominantly, i.e. at least 50% by weight, particularly preferably at least 80% by weight, especially at least 90% by weight, polyvinyl alcohol. A PVOH-based barrier sublayer is preferably formed on an outer face of one of the film layers or as a coating between the first and second film layers.

According to a particularly preferred embodiment, the barrier layer has a thickness between 1 μm and 10 μm, preferably between 3 μm and 5 μm, in particular about 4 μm. With such a film thickness, relative to a thickness of the film composite of between about 100 μm and 200 μm, foreign-material components of the barrier sublayer (for example from EVOH) can be recycled well in a mixture with predominantly PE, linear PE, PE-m and/or PP.

According to a particularly preferred embodiment, several, preferably all, film layers of the film composite have at least two laminated-together film sublayers. The advantage of increased stability and reduced tendency to corrugation generated by the use of the integrally blocked film sublayer comes to bear more strongly with a plurality of integrally blocked film sublayers.

In the case of a three-layer structure of the film composite comprising a print layer, a barrier layer and a seal layer, within the scope of the invention at least the seal layer is preferably formed with two integrally blocked film sublayers.

Preferably, however, the outer print layer can also have two integrally blocked film sublayers. It is also conceivable that, in addition to the seal layer, only the barrier layer comprises two integrally blocked sublayers. Very preferably, the print layer, the barrier layer and the seal layer each have at least two integrally blocked film sublayers.

The thickness of the first layer (in particular as a print layer) is preferably between 20 μm and 50 μm, preferably about 30 μm.

Furthermore, the second film layer (in particular as a seal layer) has a thickness of between 60 μm and 250 μm, in particular between 100 μm and 180 μm.

A third film layer arranged between the first film layer and the second film layer (in particular as a barrier) also preferably has a thickness of between 20 μm and 80 μm, in particular between 20 μm and 50 μm.

Within the scope of the present invention, the film layers of the film laminate can be joined together in a conventional manner. In particular, they are bonded to each other over the entire surface by a laminating adhesive, in this case, one also speaks of a film laminate. The laminating adhesive is preferably PUR-based (polyurethane-based). Within the scope of the invention, film layers of the film laminate can also be joined together by thermal lamination or extrusion lamination.

Formulated differently, the invention also relates to the use of at least one unstretched and integrally blocked film sublayer in a laminate or film composite in combination with an at least uniaxially stretched second film layer.

Within the scope of the invention, the following film layer arrangements in particular are preferred:
1.) Unblocked first film layer with polyethylene oriented in the machine direction (MDO-PE), multilayer unblocked middle film layer with film layers of PE-EVOH-PE and second film layer with blocked PE layers.
2) Blocked first film layer with polyethylene oriented in machine direction (MDO-PE), multilayer unblocked middle film layer with film layers of PE-EVOH-PE and second film layer with blocked PE layers.
3) Unblocked first film layer with polyethylene oriented in machine direction (MDO-PE), multilayer blocked middle film layer with film layers of PEEVOH-PE and second film layer with blocked PE layers.
4) Blocked first film layer with polyethylene oriented in machine direction (MDO-PE), multilayered blocked middle film layer with film layers of PEEVOH-PE and second film layer with blocked PE layers. The layer sequence of the middle film layers is not limited to a polyethylene layer, an EVOH layer and a further PE layer, but can also include other film layers arranged around and/or between them.

A further aspect of the invention relates to a film packaging, in particular a packaging bag having an interior space that is delimited by at least one wall. According to the invention, it is provided that the wall is formed from a film composite as previously described.

### Design Examples

A series of tests were carried out on the mode of action of the present invention, in which a conventional and an improved prior-art film material were compared with a variant according to the invention. In order to be able to compare the film composites qualitatively and quantitatively, the comparison samples were designed with an identical overall thickness.

The three comparison films each had a three-layer structure with an outer layer (print layer), a middle barrier layer and an inner seal layer. In order to keep the results comparable, the print layer and the barrier layer of the comparative examples were identical:

In the following compositions, the polymer materials of the polyethylene (PE) group used in the tests are to be understood, in accordance with the usual classification, in the following density classes, the density (unless otherwise stated) being given in each case in the unit of grams per cubic centimeter (g/cm³) and the proportions in each case as percent by weight (wt. %):

Without additional information, ordinary polyethylene is divided into three density classes:
LDPE (low density PE) between 0.915 and 0.927 g/cm³,
MDPE (medium density PE) with a density between 0.928 and 0.940 g/cm³ and
HDPE (high density PE) with a density range between 0.941 and 0.963 g/cm³.

With linear polyethylenes, a distinction is usually made between
ULDPE (ultra low density PE) between 0.860 and 0.899 g/cm³,
VLDPE (very low density PE) between 0.900 and 0.917 g/cm³,
LLDPE (linear low density PE) between 0.918 and 0.927 g/cm³,
LMDPE (linear medium density PE) between 0.928 and 0.940 g/cm³ and
LHDPE (linear high density PE) between 0.941 and 0.963 g/cm³.

Linear polyethylenes are ethylene-α-olefin copolymers that can be mixed with the homopolymers LDPE, MDPE and HDPE without restrictions and have very similar properties. Therefore, they do not restrict recyclability and can be classified without restriction as polyethylenes in the sense of a monomaterial.

The metallocene-catalyzed material classes VLDPE-m and LLDPE-m usually exhibit the same density range as their usual linear counterparts (0.900-0.917 g/cm³ and 0.918-0.927 g/cm³, respectively). Only the classes of medium and heavy metallocene-catalyzed polyethylenes exhibit a comparatively higher density of 0.928 to 0.947 g/cm³ for LMDPE-m and 0.948 to 0.963 g/cm³ for LHDPE-m.

The copolymers of polyethylene EVA (ethylene vinyl acetate), EMA (ethylene methyl acrylate), EBA (ethylene butyl acrylate) and EAA (ethylene acrylic acid) each have densities of more than 0.92 g/cm³. Copolymers such as COC (cycloolefin copolymers) can be considerably higher, with a density of about 1.02 g/cm³. Copolymers containing ethylene can also be classified, at least to a limited extent, as polyethylenes in the sense of a single-component material. Nevertheless, they should only be present in small quantities.

In order to pursue a “one-component” strategy, foreign polymers without any ethylene content, on the other hand, should be avoided. The target is to use at least 95 wt. % of homopoylmers and linear copolymers.

The composite for all samples was formed as a three-layer coextruded film laminate with a first sublayer (outer layer of 7 μm thickness) made of a mixture of HDPE and LMDPE. The second core sublayer had a thickness of 11 μm and was formed from a mixture of HDPE, LLDPE and MDPE. The third inner sublayer in the film laminate that was back printed, was again made from a mixture of HDPE and LMDPE with a thickness of 7 μm. The overall density of the whole system in the embodiment example was 0.94 g/cm³. The outer layer was also uniaxially stretched in the machine direction and thus oriented.

The barrier layer had a symmetrical five-layer structure with two outer sublayers (bonded to the outer layer and to the seal layer) of 9 μm polyethylene. Two adhesion promoter layers of 4 μm each of a polyethylene copolymer (PE-MAH) grafted with maleic anhydride follow. Between the two adhesion promoter layers, a 4 μm thick layer of ethylene-vinyl alcohol copolymer (EVOH) with an ethylene content of about 32% was formed as an oxygen and grease barrier.

The three comparison samples differed only with regard to the structure in the seal layer that had a thickness of 160 μm in all three cases.

1. Reference Sample (state of the art) The first prior art comparative sample had a seal layer with a three-layer coextruded structure. The first seal sublayer of 40 μm comprised a polymer mixture of 70% LMDPE with a density of about 0.93 g/cm³ and a melt flow index (MFI) of 0.5 g/10 min and 30% of an LLDPE with a density of 0.92 g/cm³ and a melt flow index of 1.5 g/10 min.

The subsequent second seal sublayer had a thickness of 80 μm and was made of the same mixture as the first seal sublayer. The third seal sub layer (the actual seal layer for bonding with other films or film laminates) was 40 μm of a mixture of 55% of a polyethylene plastomer with a density of 0.9 g/cm³ and a melt flow index of 1.4 g/10 min, 40% of ethylene vinyl acetate (EVA) with a vinyl acetate content of 2.5%, a density of 0.924 g/cm³ and a melt flow index of 1.2 g/10 min and 5% of an LDPE with a density of 0.91 g/cm³ and a melt flow index of 2 g/10 min were provided. This formulation guarantees a low melting temperature so that targeted melting of the innermost seal sublayer can be ensured in the largest possible welding window without affecting the outer sublayer of MDOPE.

2. Comparison Pattern (State of the Art)

In a second prior art comparative sample, an improved formulation was used for the sealing film, resulting in improved mechanical properties. The film laminate had an identical outer and barrier layer.

The seal layer used in sample 2 consisted of a three-layer coextruded film laminate with a first layer (turned toward the barrier layer) of 40 μm thickness. This was formed from a mixture of 70% of an LMDPE with a density of 0.93 g/cm³ and a melt flow index of 0.5 g/10 min and 30% of an LLDPE with a density of 0.92 g/cm³ and a melt flow index of 1.5 g/10 min. This film layer contributed to a particularly high toughness of the seal layer and thus of the film composite.

The first layer was followed by a second 80 μm thick layer of 100% HDPE with a density of 0.96 g/cm³ and a melt flow index of 0.6 g/10 min. This core layer of the seal layer particularly increased the strength and stiffness of the film composite.

For improved sealing properties, a third layer, also 40 thick, was provided on the inside, consisting of 65% of a PE plastomer with a density of 0.9 g/cm³ and a melt flow index of 1.4 g/10 min, 35% of an ethylene-vinyl acetate copolymer with a vinyl acetate content of 2.5 wt. %, a density of 0.924 g/cm³ and a melt flow index of 1.2 g/10 min, and 5% of an LDPE with a density of 0.91 g/cm³ and a melt flow index of 2 g/10 min.

3. Embodiment (Invention)

The seal layer of the third embodiment according to the invention was formed from an 80 μm thick three-layer coextruded blown film that was laminated with itself to form a total layer 160 μm thick. Thus, the seal layer according to the invention had a total of six layers:

The first sublayer turned toward the barrier layer, which also formed the sixth sublayer (seal sublayer), was formed with a thickness of 16 μm in the embodiment and had a mixture of 65% of a metallocene-catalyzed LLDPE-m with a density of 0.916 g/cm³ and a melt flow index of 1.0 g/10 min and 35% of a PE plastomer with a density of 0.9 g/cm³ and a melt flow index of 1.4 g/10 min. In this material composition, a low melting temperature was also found to be provided for a particularly large welding window (temperature range between the melting point of the seal sublayer and the melting point of the MDOPE outer sublayer).

This was followed by the second and fifth sublayers, respectively, as a 52 μm thick stabilizing layer with 60% of an HDPE with a density of 0.96 g/cm³ and a melt flow index of 0.6 g/10 min, 25% of a bimodal LMDPE with a density of 0.93 g/cm³ and a melt flow index of 0.5 g/10 min, and 15% of an LLDPE with a density of 0.92 g/cm³ and a melt flow index of 1.2 g/10 min. The high proportion of HDPE in particular ensured high strength and stiffness of the entire seal layer. This effect was additionally favored by the fact that the two stabilizing sublayers (second and fifth layers) were spaced in the middle by the integrally blocked third and fourth sublayers. This resulted in a so-called “plywood” effect that additionally increased the bending stiffness.

The integrally blocked third and fourth sublayers were each 12 μm thick and formed from 100% ethylene vinyl acetate copolymer (EVA) with a vinyl acetate content of 18 wt %. This plastic layer had a density of 0.94 g/cm³ with a melt flow index of 0.5 g/10 min. The high vinyl acetate content resulted in a particularly sticky plastic melt. This was advantageous because the film bubble collapsed while still heated, causing the EVA s turned toward each other to weld together. This resulted in a particularly intimate bond between the two film sublayers that, if at all, can only be distinguished under the microscope from a single continuous layer twice as thick.

As an alternative to EVA, a plastomer can also be used as a tackifying blocking agent.

Comparative Measurements

The three reference samples used had an overall identical thickness of the film composite and identical outer sublayers and barrier sublayers. This allowed a direct and quantitative comparison of the mechanical properties that were largely determined by the seal layer. Various standardized and non-standardized comparison tests were carried out for this purpose:

Within the scope of the comparative measurements, it was found that the film composite according to the invention in the third sample, with identical thickness, exhibited significantly improved flexural stiffness. The other mechanical properties and internal quality tests simultaneously delivered consistently equivalent results.

In the comparative measurements, the bending stiffness was first determined according to DIN 53121. At least five specimens were measured separately for each of the different samples. The values determined for the bending stiffness according to the invention are 50% higher than those of samples 1 and 2 taken from the prior art. This is shown in Table 1 below:

| | | Measured value: Minimum/Average/maximum | | | |
|---|---|---|---|---|---|
| | Test | State of the art | | Invention | |
| Feature | device | Sample 1 | Sample 2 | Sample 3 | Units |
| Bend Stiffness | MD | 440/453/462 | 557/572/617 | 738/749/753 | mNmm |
| | CD | 467/496/522 | 617/639/673 | 713/741/753 | |

For quality assurance purposes, further characteristic mechanical properties of the three reference samples were also measured and compared with each other. Thus, in a further measurement campaign, the properties of the film mechanics were determined according to ISO 527-1 from five individual samples in each case. The results show an overall equivalent and consistent behavior of the film composite according to the invention compared to the generic reference samples. The results are shown in Tab. 2 below:

| | | Measured value: Minimum/Average/maximum | | | |
|---|---|---|---|---|---|
| | Test | State of the art | | Invention | |
| Feature | device | Sample 1 | Sample 2 | Sample 3 | Units |
| Stretch to break | MD | 94/97/100 | 101/104/107 | 102/106/109 | N/15 mm |
| | | 27/28/29 | 30/31/32 | 29/30/31 | N/mm² |
| E-modulus | | 315/322/338 | 447/456/464 | 380/398/418 | N/mm² |
| Stretch at break | | 55/60/70 | 58/64/68 | 61/65/62 | % |
| Stretch to break | CD | 62/67/70 | 63/64/65 | 60/67/74 | N/15 mm |
| | | 19/20/20 | 19/19/19 | 17/20/22 | N/mm² |
| E-modulus | | 319/333/347 | 457/460/464 | 411/425/438 | N/mm² |
| Stretch at break | | 919/985/1045 | 224/359/556 | 750/910/1025 | % |

The film laminates were also subjected to a test of puncture resistance according to DIN 14477. For this purpose, ten individual measurements were carried out in each case on finished bags made of the various sample materials from the inside toward the outside, corresponding to an into-out puncture direction from the seal layer toward the outer sublayer. In this test, too, the film laminate according to the invention showed equivalent resistance to the prior art samples.—According to Table 3:

| | Measured value: Minimum/Average/maximum | | | |
|---|---|---|---|---|
| | State of the art | | Invention | |
| Test device | Sample 1 | Sample 2 | Sample 3 | Units |
| Bag puncture | 6.5/7.1/7.6 | 7.3/7.6/8.3 | 7.0/7.6/8.1 | N |
| in to out | | | | |

Furthermore, the applicant also carried out comparative tests in accordance with DIN 55529, whereby the weld seams were produced in a bag plant. Thus, the strength of the weld seams was compared in another comparative test.

For this purpose, film pouches were first produced from the composite materials to be compared. The transverse weld seam investigated in the bottom area of the film pouches was joined together with permanently heated welding jaws in a welding time of 0.7 seconds. The upper welding jaw had a temperature of 230° C. and the lower welding jaw had a temperature of 215° C.

Subsequently, 15 mm wide and at least 100 mm long strips perpendicular to the seams were cut out of the made-up bags. The ends of these samples were clamped in a tensile testing machine so that the sealed seam was centered between the clamping jaws. The distance between the jaws was 50 mm at the beginning of the test procedure. Then the force required to loosen the 15 mm seal seam was measured in newtons. As can be seen from Table 4 below, the weld seam strength of the film composite according to the invention corresponds to the values from the prior art:

| | Measured value: Minimum/Average/maximum | | | |
|---|---|---|---|---|
| Seam | State of the art | | Invention | |
| position | Sample 1 | Sample 2 | Sample 3 | Units |
| Cross seam | 46/47/49 | 55/59/62 | 49/53/55 | N/15 mm |

The structural integrity of the bags produced from the different reference materials was checked in a practical test. For this purpose, the bags were filled with a plastic granulate. Due to the selected bag format and in accordance with the application, a specified filling quantity of 15 kg of dry feed was selected for the comparison bags. The bags were each dropped to the ground from a height of 1 m in different orientations. The orientations were selected in such a way that the filled bags hit the ground with the front face, the back face and a bottom surface. None of the test bags used suffered any damage. In particular, no foil parts of the bag were destroyed or weld seams detached.

Direct comparison of the samples also demonstrated the reduced waviness and improved flatness of the material according to the invention. For this purpose, several film packaging bags made of the respective materials were placed on top of each other in a joint. In this case, the joint of bags made of the material according to the invention in the force-free state achieved a height reduced by about 50% compared to the test bags made of material 1 or 2.

The comparative measurements of the embodiment demonstrate improved mechanical properties of the single-material film composite according to the invention. This can provide an adequate substitute for conventional film composites.

A conventional multimaterial film composite with a 20 μm thick outer layer of oriented polypropylene (OPP), an intermediate layer of 12 μm made of metalized polyethylene terephthalate (PET-met) and a seal layer of polyethylene with a thickness of 140 μm can be used as a benchmark.

This results in a composite thickness of about 172 μm (plus adhesive and print sublayers).

In order to achieve comparable mechanical properties and also a sufficient barrier function, significantly greater layer thicknesses were previously required in the state of the art as a “single-material” layer. For example, comparable properties could be achieved with a film composite consisting of 25 μm of a machine-direction oriented polyethylene (MDOPE), 30 μm of a metallized PE film (possibly with coextruded EVOH barrier sublayer or uniaxially stretched), and a PE seal layer of 140 μm. However, this film composite has a significantly greater overall thickness of at least 195 μm and correspondingly higher material consumption and environmental impact.

Due to the improved specific bending stiffness of the seal layer according to the invention, its layer thickness in the overall composite can be reduced. Thus, within the scope of the invention, an additional mass reduction is possible while retaining overall equivalent mechanical performance. In the interaction of an integrally blocked MDOPE print layer of 30 μm with an integrally blocked PE-EVOH-PE barrier layer of 60 μm and an 80 μm thick integrally blocked barrier sublayer, equivalent mechanical properties can be achieved with an overall net thickness of 170 μm. The teaching according to the invention can therefore even reduce the film composite overall compared to multimaterial laminates.

### BRIEF DESCRIPTION OF THE DRAWING

The invention is described below with reference to a single embodiment illustrated in the drawing that shows a cross-section through a polyolefin-based film composite.

### SPECIFIC DESCRIPTION OF THE INVENTION

As shown in the drawing, a film composite 1 according to the invention has a first film layer 2 stretched uniaxially in a machine direction and a second film layer 3 indirectly connected to the first film layer 2.

The first film layer 2 is carries indicia or printing 4 on its face turned toward the second film layer 3. This printing 4 is a mixture of a binder and pigments.

Furthermore, the first film layer 2 is a three-layer coextruded film laminate with a first outer sublayer 2a made of a mixture containing HDPE and LMDPE, a core sublayer 2b of a mixture of HDPE, LLDPE and MDPE, and an inner sublayer 2c carrying the printing 4 and consisting of a 7 μm thick mixture of HDPE and LMDPD. The total thickness a of the first film layer 2 is 25 μm with an overall density of 0.94 g/cm³.

A third film layer 5 is a barrier between the first film layer 2 and the second film layer 3. This barrier layer 5 is a symmetrical five-layer coextruded film laminate with 9 μm thick outer first and fifth film sublayers 5a and 5e made of polyethylene. Adhesion second and fourth promoter sublayers 5b and 5d, are made of a polyethylene grafted with maleic anhydride, and are next to the respective sublayers 5a and 5e. The core of the barrier layer 5 is formed by a 4 μm thick oxygen and grease barrier sublayer 5c made of EVOH with an ethylene content of 32 wt. %. The first and fifth film sublayers 5a and 5e are fully positioned on the respective first layer 2 and the second layer 3 via respective polyurethane-based laminating adhesive sublayers 6a and 6b.

The second film layer 3 is opposite the first film layer 2 on an outer face of the film composite 1 and is formed as a seal. It is formed from a collapsed three-layer extruded film tube to form a six-layer laminate in which the first film sublayer 3a is turned toward and positioned on the barrier layer 5. This sublayer 3a and the sixth outwardly turned film sublayer 3f of the second film layer 3 are formed from a mixture of 65 wt. % PE-LLD-m and 35 wt. % of a PE plastomer with a thickness of 16 μm. Second and fifth core sublayers 3b and 3a of the seal layer 3 are each 52 m thick and made of a mixture of 60 wt % PE-HD, 25 wt % of a bimodal LMDPE and 15 wt % of a LLDPE. The particularly high HDPE content improves the strength and rigidity of the seal layer 3.

According to the invention, the second film layer 3 has a third film sublayer 3a and a fourth film sublayer 3d that are integrally blocked with each other according to the invention. The third film sublayer 3a and the fourth film sublayer 3d are formed from 100% by weight EVA with a VA content of 18% by weight. This high VA content improves them adhesiveness, especially when heated and being laminated together. The two EVA sublayers 3a and 3d bonded together each have a thickness of 12 m for a total thickness of 24 m.

In the illustrated embodiment, the first film layer 2 has the thickness a of 25 m. The second film layer 3 has a thickness b of 160 m. The barrier layer 5 has a thickness c of 30 m.

We claim:

1. A polyolefin-based film composite comprising:
a uniaxially stretched first film layer; and
a second film layer bonded directly or indirectly to the first film layer, the second film layer being unstretched and having at least two integrally blocked film sublayers.

2. The film composite according to claim 1, wherein the first film layer carries indicia or printing.

3. The film composite according to claim 1, further comprising:
at least one third film layer.

4. The film composite according to claim 1, wherein the second film layer is on an outer face of the film composite and is a seal layer.

5. The film composite according to claim 4, wherein the seal layer has a weight content of at least 30% of high-density polyethylene.

6. The film composite according to claim 5, wherein the high-density polyethylene is exclusively in one or more core sublayers.

7. The film composite according to claim 4, wherein the seal layer itself has at least one seal sublayer comprising at least 20% by weight of polyethylene having a density of not more than 0.905 g/cm³.

8. The film composite according to claim 7, wherein the seal layer contains at least 70% by weight of polyethylene with a density of not more than 0.92 g/cm³.

9. The film composite according to claim 4, wherein the seal layer is at least 30% by weight formed by a polyethylene plastomer.

10. The film composite according to claim 1, wherein all film layers are based on polyethylene.

11. The film composite according to claim 1, wherein all film layers are based on polypropylene.

12. The film composite according to claim 1, wherein the film layers each have at least two film sublayers integrally blocked with one another.

13. The film composite according to claim 1, wherein at least one of the film layers is of multilayer structure including a barrier sublayer of ethylene-vinyl alcohol copolymer.

14. The film composite according to claim 13, wherein the barrier sublayer has a thickness of at most 10 m.

15. The film composite according to claim 1, wherein the first film layer has a thickness between 20 m and 50 m.

16. The film composite according to claim 1, wherein the second film layer has a thickness of between 100 m and 180 m.

17. The film composite according to claim 16, wherein the first film layer and the second film layer have a total thickness of between 120 m and 200 m.

18. A packaging bag having an interior space defined by a sheet of a film formed by the composite of claim 1.
